(19) United States
(12) Patent Application Publication
(10) Pub. No.: US 2026/0275129 A1
(43) Pub. Date: Sep. 17, 2026

(54) COMPOSITION COMPRISING AN ASSOCIATIVE THICKENER

(71) Applicant: BYK-CHEMIE GmbH, Wesel (DE)

(72) Inventors: René Nagelsdiek, Hamminkeln (DE); Christiane Knappke-Bongartz, Haan (DE); Sylvia Bühne, Duisburg (DE); Diana Ackermann, Velen (DE); Christian Sauerländer, Oberhausen (DE); Johann Meike, Duisburg (DE)

(21) Appl. No.: 19/168,026

(22) PCT Filed: Mar. 22, 2024
(86) PCT No.: PCT/EP2024/057747

§ 371 Date: Sep. 23, 2025

(30) Foreign Application Priority Data
Mar. 24, 2023 (EP) 23163968.3

(51) Int. Cl. C09D 7/43; C08K 5/101; C08K 5/41; C08L 67/02; C09D 5/02

(52) U.S. Cl. CPC C09D 7/43; C08K 5/101; C08K 5/41; C08L 67/02; C09D 5/028

(57) ABSTRACT

The invention deals with a thickener composition comprising at least one anionic surfactant, and at least one associative thickener, wherein the associative thickener comprises at least one polyether segment, and at least one hydrophobic segment according to formula (I) where R⁴ is independent of each occurrence hydrogen, alkyl, cycloalkyl, aryl or arylalkyl.

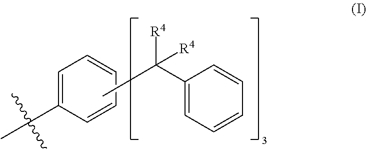

The invention relates to a thickener composition comprising at least one anionic surfactant, and at least one associative thickener, wherein the associative thickener comprises at least one polyether segment, and at least one hydrophobic segment. The invention further relates to a liquid composition comprising the thickener composition, the use of the composition for improving the tinting viscosity stability of a pigmented liquid composition, a method for improving the tinting viscosity stability of a liquid composition, and a coated article.

In the field of coating materials, adhesives, sealants, and molding compounds, as well as oil-field drilling fluids and the like, it is necessary to customize the rheological properties of such liquid systems, primarily through adjusting the viscosity and the flow behavior. This can for example be done by the selection of binding agents, solvents, and the concentration of pigments and/or fillers. Often, the addition of so-called rheology additives to these liquids is required. The effect of these additives lays in adjusting the rheological properties of the system, like the viscosity and the viscoelastic properties. The additives may be used to increase or maintain the viscosity of compositions used in applications including, but not limited to, latex paints, cleaning agents, cosmetics, aqueous pigment pastes, automotive finishes, industrial coatings, printing inks, lubricating greases, textile coatings, pharmaceutical preparations, agricultural formulations, filler dispersions, adhesives, detergents, wax dispersions, drilling fluids, fire-fighting foams, and/or polishes. Such additives are commonly referred to as “thickeners”. Thickeners may improve and/or affect other properties in certain application systems, particularly in aqueous systems. For example, associative thickeners used in latex paints may improve and control the viscosity of the paint, protect colloidal action, and improve pigment suspension, leveling, and flow. Although associative thickeners for aqueous systems have been used to thicken waterborne compositions, improved thickeners for use in waterborne compositions that include high amounts of pigments and/or intensely colored pigments are needed. When using associative thickeners in water-based formulations, like paints, there is often the undesired side effect, that the tinting viscosity is not stable. That means, that the viscosity of the paint changes upon tinting.

A problem that occurs in paints containing associative thickeners is a change in viscosity when pigment compositions are added to the paint formulation (tinting). This is often affecting the viscosity in the lower shear range. The low-shear viscosity is the viscosity exhibited when the applied shear rate is in the range of 0.1 s⁻¹ to 400 s⁻¹. Low shear conditions are typically experienced by the paint while it is in the can and immediately after it has been applied to the wall. During these phases, appropriate low shear viscosity is needed to resist pigment settling and film sag but providing the required levelling of the applied paint film. As the colored paint market continues to grow, the currently available approaches to mitigating viscosity change all have limitations. Thus, there is an ongoing need to provide compositions which can be used as an additive in water-based paint and coating formulations that reduce the viscosity change upon tinting.

Combinations of two or more associative thickeners for example are used in paints to obtain the desired balance of high and low shear viscosities. These common combinations include a pseudoplastic associative thickener to control the low to mid shear viscosity and a more Newtonian associative thickener to control the high shear viscosity. US 2007/0155880 discloses that by selecting two associative thickeners of a higher and a lower molecular weight and utilizing them in combination in certain concentration ratios.

Therefore, there is still an ongoing need to provide improved associative thickeners for water-based systems. Using the thickeners should lead to very reliable and increased thickening effects and should lead to a high stability of the viscosity upon tinting. Moreover, they should show a positive influence on gloss and color stability of the applied application system.

Thus, it is a particular object of the present invention to provide a high-quality thickener composition of good effectiveness, which leads to an improvement in tinting viscosity stability in water-based application systems. Another object of the invention is to provide an associative thickener composition that leads to an improvement in gloss and color stability in the applied paint.

Surprisingly, it has been found that these objectives can be achieved by a thickener composition comprising at least one anionic surfactant, and at least one associative thickener, wherein the associative thickener comprises
at least one polyether segment, and
at least one hydrophobic segment according to formula (I)

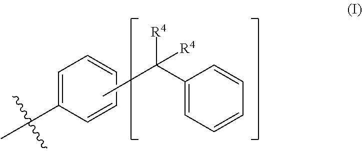

where R⁴ is independent of each occurrence hydrogen, alkyl, cycloalkyl, aryl, arylalkyl, preferably hydrogen, methyl, butyl, phenyl, benzyl, and wherein the at least one associative thickener comprises at least one of a HEUR and a HEAT thickener.

The term “associative thickener” means a nonionic, hydrophobically modified water-soluble polymer capable of interacting in aqueous solution with itself and with other species such as latex particles.

The different types of associative thickeners include, but are not limited to polyurethanes, polyesters, modified cellulosics, polyester-urethanes, polyether-alpha olefins, aminoplast-ether copolymers and polyether-polyols. Preferably, the associative thickener comprises at least one of the aforementioned compounds.

Associative thickeners generally include one or more hydrophilic portions coupled together with one or more hydrophobic portions. In some embodiments of associative thickeners, one or more hydrophilic portions are linked to one or more hydrophobic portions through one or more coupling portions. In some embodiments, coupling portions may be di-functional portions, tri-functional portions, or higher functional portions. A di-functional coupling portion may be coupled to any combination of two portions selected from hydrophilic portions and/or hydrophobic portions. Tri-functional coupling portion may be coupled to any combination of three hydrophilic portions and/or hydrophobic portions. It should be understood that it is not required that each hydrophobic and each hydrophilic portion has to be identical. In some embodiments, some or all of the hydrophobic portions and hydrophilic portions are different. In certain embodiments, all of the hydrophobic portions may be identical, and all of the hydrophilic portions may be identical. The same holds true regarding the coupling portions. When multiple coupling portions are present, the coupling portions may be identical or may be different.

The reactants forming the hydrophilic portions of an associative thickener are generally at least di-functional to allow coupling to at least two different reactants forming the coupling portions. In some embodiments, they are di-functional.

The reactant forming the hydrophilic portion of the associative thickener is a polyether (also known as a polyether polyol). Polyethers may be adducts of an aliphatic, cycloaliphatic or aromatic polyhydroxy compound with an alkylene oxide. Polyhydroxy compounds include, but are not limited to, polyhydric alcohols or polyhydric alcohol ethers.

Alkylene oxide compounds include, but are not limited to, ethylene oxide and/or propylene oxide. Polyhydric alcohols include, but are not limited to, glycols, polyalkylene glycols, hydroxy compounds containing three or more hydroxyl groups, or mixtures thereof. Glycols include, but are not limited to, ethylene glycol and/or propylene glycol. Hydroxy compounds containing three or more hydroxyl groups include, but are not limited to, glycerol, erythritol, sorbitol, mannitol, trimethylol propane, pentaerythritol or mixtures thereof. Polyalkylene glycols include, but are not limited to, polyethylene glycol, polypropylene glycol, polybutylene glycol, or mixtures and copolymers thereof. Polyalkylene glycols may have a number average molecular weight between 2,000 and 35,000 g/mol. Cycloaliphatic polyhydric alcohols include, but are not limited to, 1,2-cyclopentanediol, 1,4-cyclohexandiol and/or hexahydroxycyclohexane. Aromatic polyhydric alcohols may include, but are not limited to, di-hydroxybenzene and trihydroxybenzene.

Preferred are polyethylene glycols, particularly polyethylene glycols having a number average molecular weight in the range of from 2000 to 25,000 g/mol, preferably in the range of from 4000 to 15,000 g/mol. An example of a suitable polyethylene glycol is PEG 8000.

The hydrophilic portion of the associative thickener may be bonded to one or more coupling portions. Coupling portions may result from reactants, which include two or more isocyanate groups (i.e., polyisocyanates). These reactants may be aliphatic, cycloaliphatic, and/or aromatic isocyanates. Examples of polyisocyanates that may be used as coupling portions include, but are not limited to: 1,4-tetramethylene diisocyanate; 1,5-pentamethylene diisocyanate; 1,6-hexamethylene diisocyanate (HDI); 2,2,4-trimethyl-1,6-diisocyanatohexane 2,4,4-trimethyl-1,6-diisocyanatohexane; 1,10-decamethylene di-isocyanate; 1,4-cyclohexylene diisocyanate; 4,4′-methylenebis(isocyanatocyclohexane); 1,3-bis(2-isocyanatopropan-2-yl)benzene (TMXDI); 1-isocyanato-3-isocyanatomethyl-3,5,5-trimethylcyclohexane; m- and p-phenylene di-isocyanate; 2,6- and 2,4-toluene diisocyanate (TDI); xylene diisocyanate; 4-chloro-1,3-phenylene diisocyanate; 4,4′-biphenylene diisocyanate; 4,4′-methylene di(phenylisocyanate) (“MDI”); 1,5-naphthylene di-isocyanate; 1,5-tetrahydronaphthylene diisocyanate; polymethylene poly(phenylisocyanate); isophorone di-isocyanate (IPDI). Moreover, the dimers and trimers of these polyisocyantes (i.e., their uretdiones and isocyanurates) are also suitable polyisocyanates which can be used as reactants to prepare the associative thickener.

The polyisocyanates may contain any number of carbon atoms effective to provide the required degree of hydrophobic character. In some embodiments, the number of carbon atoms ranges from 4 to 30 atoms, or from 8 to 25, or from 10 to 20. In the case of uretdione dimers and isocyanurate trimers, the number of carbon atoms of the isocyanate is suitably in the range of 10 to 50, preferably 12 to 40, more preferably 14 to 36. The number of carbon atoms may be selected based upon on the proportion of the other hydrophobic groups and hydrophilic group in the product.

In some embodiments, polyisocyanates also include any polyfunctional isocyanate derived from the reaction of any polyisocyanate and an active hydrogen compound having a functionality of at least two such that some isocyanate groups remain unreacted. Such isocyanates are equivalent to chain-extending an isocyanate terminated isocyanate/diol reaction product with a reactant containing at least two active hydrogen atoms in a manner well known in polyurethane synthesis.

In some embodiments, the one or more coupling portions of the associative thickener are bonded to one or more hydrophobic portions. Hydrophobic portions of a nonionic associative thickener may contact and/or interact with the surface of particles in the application system. For example, the hydrophobic portion may interact with a surface of a filler or the surface of a latex particle used in a paint.

In some embodiments, the associative thickener may be derived from one or more di-isocyanate groups and/or isocyanurate trimer groups as coupling portions. The isocyanate groups may be reacted with one or more hydrophilic portions described herein.

In some embodiments, the polyisocyanates mentioned can be used in combination with monoisocyanates. Monoisocyanates contain only one isocyanate group; preferably, these monoisocyanates contain one isocyanate group bound to a hydrocarbyl group having 4 to 24 carbon atoms, more preferably a hydrocarbyl group having 6 to 20 carbon atoms, such as a alkyl group having 16 to 18 carbon atoms or alkenyl group.

The at least one associative thickener comprises at least one of a HEUR and a HEAT thickener.

Hydrophobically modified ethoxylated urethane thickeners (HEURs) are water soluble polymers containing hydrophobic groups and are classified as associative thickeners because the hydrophobic groups associate with one another in water. In a paint formulation, the hydrophobic groups can for example adsorb to latex particle surfaces, thereby creating loops and bridges between particles, to form a transient network of bridged latex particles that gives rise to viscosity increase and desirable rheological characteristics over a wide range of shear rates.

Likewise, HEAT (hydrophobically modified ethoxylated aminoplast thickener) thickeners, which are aminoplast-ether copolymers containing aminoplast segments interlinked through ether segments as described in U.S. Pat. Nos. 5,627,232 A1 and 5,914,373 A1, are classified as associative thickeners.

The hydrophobic portion of the associative thickener may include alkyl groups, arylalkyl groups, and aromatic groups, or combinations thereof. In the invention, the hydrophobic portion includes sterically hindered groups: more than one aromatic group bonded to a benzene ring.

Suitably, the associative thickener is an associative thickener according to formula (II)

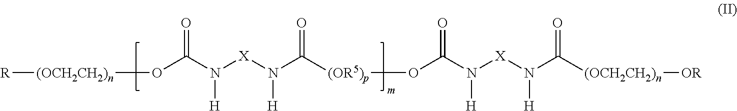

Wherein R is at least one of an hydrophobic segment according to formula (I) and an aliphatic or cycloaliphatic group with 7 to 20 carbon atoms, with the proviso that at least one R is a hydrophobic segment according to formula (I); m is ≥1; n independent of each other is ≥0; p ranges from 45 to 500; R⁵ is selected from C₂H₄ and C₃H₆ with the proviso that at least 70 mole % of R⁵ is represented by C₂H₄;
and X is independent of each occurrence

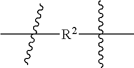

where R² is aliphatic, cycloaliphatic, or aromatic; or X is

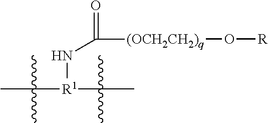

where q is ≥0, and R is as defined above;
where R¹ is:

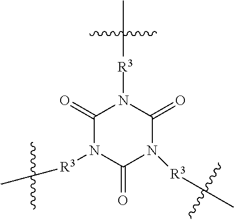

where R³ is aliphatic, cycloaliphatic, or aromatic.

Preferably, the R in formula (II), that are not represented by formula I, are aliphatic or cycloaliphatic groups with 6 to 24 carbon atoms, more preferably with 8 to 20 carbon atoms and most preferably with 9 to 18 carbon atoms.

In another embodiment, m is from 1 to 10 and more preferred from 1 to 7, n is from 0 to 40 and more preferred from 1 to 35, q is from 0 to 40 and more preferred from 1 to 35 and p ranges from 40 to 500 and more preferred from 100 to 300.

In a preferred embodiment m is from 1 to 4, n from 10 to 22, q from 10 to 22, p ranges from 120 to 220, and R is a hydrophobic segment according to formula (I).

In a further embodiment, at least one X is

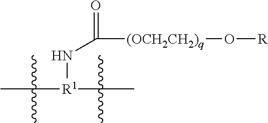

In some embodiments, R² and/or R³ includes:

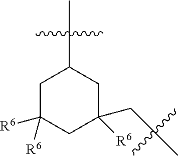

where R⁶ is aliphatic, cycloaliphatic, aromatic, heterocyclic, or combinations thereof. In certain embodiments, R⁶ is methyl.

In a further embodiment R² and/or R³ is

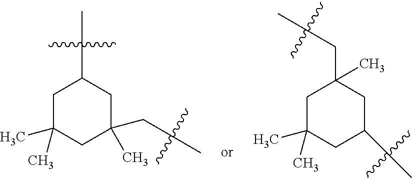 [SMILES: *CC1(C)CC(*)CC(C)(C)C1 ; *CC1(C)CC(*)CC(C)(C)C1]

In all formulae the bond or bonds crossed by a wiggled line indicate the attachment point of the structural segment to the parent structure.

The associative thickener may be prepared according to techniques generally known in the art for preparing urethanes such that substantially all of the isocyanate groups of the reactants are reacted. In some embodiments, solvent polymerization methods known in the art may be used to prepare the associative thickener. In certain embodiments, melt polymerization methods known in the art may be used to prepare the associative thickener.

Preferably, the at least one associative thickener has a number average molecular weight Mn in the range of 4000 g/mol to 80000 g/mol. More preferably, the at least one associative thickener has a number average molecular weight Mn in the range of 5000 g/mol to 70000 g/mol, even more preferably the at least one associative thickener has a number average molecular weight Mn in the range of 6500 g/mol to 60000 g/mol and most preferably the at least one associative thickener has a number average molecular weight Mn in the range of 8000 g/mol to 40000 g/mol.

The number and weight average molecular weights can be determined by gel permeation chromatography (eluent: THF, standard: polystyrene, column temperature: 25° C.) according to DIN EN ISO 13885-1 (November 2021). Alternatively, the number average molecular weight may be determined by calculation.

The thickener composition according to the invention comprises an anionic surfactant. Anionic surfactants are e. g., sulfosuccinates, alk(en)yl sulfates, alk(en)yl ether sulfates, ester sulfonates, soaps, ether carboxylic acids.

Anionic surfactants useful in this invention are characterized by having carboxylates, sulfonates, sulfates, or phosphates as their hydrophilic, solubilizing group. These groups are preferably combined with a carbon-chain hydrophobe having, e.g., 8 to 16 carbon atoms, that is optionally alkoxylated. Suitably, the anionic surfactant comprises at least one of an alkyl ether sulfate, aryl ether sulfate, alkyl sulfate, aryl sulfate, dialkylsulfosuccinate.

In a preferred embodiment, the anionic surfactant is carrying a sulfate group or sulfuric acid group. More preferably, the anionic surfactant has the following structure (III)

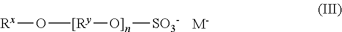

in which
the counterion M⁺ is selected from Na⁺, K⁺, and NH₄⁺,
R^{x} is representing a tristyrylphenyl group or a C8 to C20 alkyl or alkenyl group, more preferably a C9 to C18 alkyl or alkenyl group, even more preferably a C10 to C16 alkyl or alkenyl group,
R^{y} is representing a group selected from C₂H₄ and C₃H₆,
n is an integer from 0 to 35, preferably from 1 to 30, more preferably from 2 to 25, such as from 3 to 20.

It is very preferred that, in the anionic surfactant of the structure (III), R^{X} is representing an alkyl group, most preferably a linear alkyl group.

It is furthermore preferred that at least 50 mole %, preferably at least 70 mole %, more preferably at least 90 mole % of all R^{y} groups represent C₂H₄. In a very preferred embodiment, all groups R^{y} represent C₂H₄.

It is furthermore preferred that n is an integer from 3 to 16.

Suitably, the anionic surfactant comprises at least one of tristyrylphenol ether sulfate, ammonium laureth sulfate, sodium laureth sulfate, sodium lauryl ether sulfate, ammonium lauryl ether sulfate, sodium alkylbenzene sulfonates, sodium isotridecyl ethersulfate.

Preferably, the anionic surfactant is employed in amounts of 5 to 65% by weight, more preferably 10 to 55% by weight, even more preferably 15 to 50% by weight, and most preferably 20 to 45% by weight, such as 25 to 40% by weight, calculated on the sum of the total weight of anionic surfactant and associative thickener.

Preferably, the weight ratio of the associative thickener and the at least one anionic surfactant is in the range from 19:1 to 7:13 calculated on the total weight of the associative thickener and the anionic surfactant. More preferably, the weight ratio of the associative thickener and the at least one anionic surfactant is in the range from 17:3 to 1:1, even more preferably, the weight ratio of the associative thickener and the at least one anionic surfactant is in the range from 4:1 to 11:9, and most preferably in the range from 3:1 to 3:2, calculated on the total weight of the associative thickener and the anionic surfactant.

In a preferred embodiment, the thickener composition comprises at least one of a non-ionic surfactant. Non-ionic surfactants carry no discrete charge when dissolved in aqueous media. The solubilizing groups in this type of surfactant are usually repeating units derived from alkylene oxides as well as hydroxyl groups. Non-ionic surfactants are, for example, alcohol alkoxylates, alkyl (poly)glycosides, and fatty acid ester alkoxylates. Another class of non-ionic surfactants are random, alternating, gradient, or block copolymers of different alkylene oxides, preferable of ethylene oxide and propylene oxide, amine oxides and gemini surfactants, and mixtures thereof.

Suitably, the at least one non-ionic surfactant comprises at least one of a polyalkylene glycol monoalkyl ether, a polyalkylene glycol, an alkylpolyglycoside. Preferred polyalkylene glycols are copolymers of ethylene oxide and propylene oxide, very preferably random or block copolymers.

Suitably, the non-ionic surfactant is employed in amounts of 20 to 65% by weight, more suitably 25 to 60% by weight, even more suitably 28 to 55% by weight, most suitably 32 to 50% by weight, such as 35 to 45% by weight, calculated on the sum of the total weight of non-ionic surfactant, anionic surfactant and associative thickener.

The weight ratio of the associative thickener and the at least one non-ionic surfactant is suitably in the range from 7:3 to 1:3, calculated on the total weight of the associative thickener and the non-ionic surfactant. More suitably, the weight ratio of the associative thickener and the at least one non-ionic surfactant is in the range from 13:7 to 2:3, even more suitably in the range from 12:8 to 3:4, and most suitably in the range from 11:9 to 9:11, calculated on the total weight of the associative thickener and the non-ionic surfactant.

Preferably, the thickener composition comprises between 0 to 95% by weight of water, calculated on the total weight of the composition. More preferably, the thickener composition comprises between 20 to 90% by weight of water, even more preferably between 40 and 87% by weight of water and most preferably between 50 to 85% by weight of water, calculated on the total weight of the thickener composition.

The thickener composition suitably comprises
5.0 to 35.0 weight-% of the associative thickener,
0.5 to 30.0 weight-% of the anionic surfactant,
0.0 to 30.0 weight-% of a nonionic surfactant,
5.0 to 94.5 weight-% of water,
calculated on the total weight of the associative thickener, the anionic surfactant, the nonionic surfactant, and water.

The thickener composition preferably comprises
7.5 to 30.0 weight-% of the associative thickener,
1.0 to 25.0 weight-% of the anionic surfactant,
0.0 to 25.0 weight-% of a nonionic surfactant,
20.0 to 91.5 weight-% of water,
calculated on the total weight of the associative thickener, the anionic surfactant, the nonionic surfactant, and water.

The thickener composition more preferably comprises
10.0 to 25.0 weight-% of the associative thickener,
2.5 to 22.0 weight-% of the anionic surfactant,
0.0 to 22.0 weight-% of a nonionic surfactant,
41.0 to 87.5 weight-% of water,
calculated on the total weight of the associative thickener, the anionic surfactant, the nonionic surfactant, and water.

The thickener composition very preferably comprises
12.0-20.0 weight-% of the associative thickener,
5.0-10.0 weight-% of the anionic surfactant,
0.0-20.0 weight-% of a nonionic surfactant,
50.0-83.0 weight-% of water,
calculated on the total weight of the associative thickener, the anionic surfactant, the nonionic surfactant, and water.

The thickener composition suitably comprises
5.0 to 35.0 weight-% of the associative thickener,
0.5 to 30.0 weight-% of the anionic surfactant,
5.0 to 30.0 weight-% of a nonionic surfactant,
5.0 to 89.5 weight-% of water,
calculated on the total weight of the associative thickener, the anionic surfactant, the nonionic surfactant, and water.

The thickener composition very preferably comprises
12.0-20.0 weight-% of the associative thickener,
5.0-10.0 weight-% of the anionic surfactant,
10.0-20.0 weight-% of a nonionic surfactant,
50.0-73.0 weight-% of water,
calculated on the total weight of the associative thickener, the anionic surfactant, the nonionic surfactant, and water.

Preferably, the thickener composition does not contain or comprise a polymeric film-forming binder. Additionally, the thickener composition suitably does not contain or comprise a pigment or pigment composition.

Additionally, the invention deals with a liquid composition comprising the thickener composition according to the invention and a binder. The term “liquid composition” according to the present invention denotes a composition, being liquid at 23° C. and 1013 mbar.

Preferably, the liquid composition is an aqueous composition. The primary or even the only liquid diluting agent of an aqueous composition suitably is water. In general, the aqueous composition comprises at least 10%, preferably at least 20%, more preferably at least 30% by weight of water. Preferably, the aqueous composition comprises from 25 to 75% by weight of water, more preferably from 30 to 65% by weight of water and most preferably from 35 to 55% by weight of water. In special embodiments, the aqueous composition comprises up to 95%, or even up to 97, 98, or 99% by weight of water.

Suitably, the liquid composition is a waterborne coating composition. Waterborne coating compositions may be made by dispersing or emulsifying a resin or via emulsion polymerization. The resin used in the coating formulation may be insoluble in water, and the conversion of such a resin into a waterborne system typically involves converting the resin into an emulsion or dispersion.

The binder is a polymeric film-forming binder resin and may be a resin and may be any of those known in the art. Suitably it is a water insoluble resin, for example a conventional natural or synthetic polymer latex.

Suitable binders comprise, but are not limited to waterborne latex systems (typically obtained by emulsion polymerization), waterborne polyurethane resins (such as polyurethane dispersions and 2-pack systems), waterborne epoxy resins, waterborne alkyd resins (such as alkyd emulsions), waterborne polyester resins, and waterborne hybrid systems.

The primary resins of latex systems are based on homopolymerized and copolymerized olefinic monomers; suitably, they can be selected from homopolymers of C₂-C₄₀ alpha-olefins; copolymers of ethylene, isobutylene, octene, nonene, or styrene with one or more esters; copolymers of ethylene, isobutylene, octene, nonene, or styrene with nitriles or amides of (meth)acrylic acid; copolymers of ethylene, isobutylene, octene, nonene, or styrene with (meth)acrylic acid and its esters and amides; copolymers of ethylene, isobutylene, octene, nonene, or styrene with vinyl esters; copolymers of ethylene, isobutylene, octene, nonene, or styrene with vinylidene chloride; copolymers of ethylene, isobutylene, octene, nonene, or styrene with diene polymers, or mixtures thereof.

Examples of homopolymerized and copolymerized olefinic monomers include, but are not limited to, vinyl acetate, vinyl chloride, styrene, butadiene, vinylidene chloride, acrylonitrile, methacrylonitrile, acrylic acid, methacrylic acid, alkyl acrylates, alkyl methacrylates, acrylamide, methacrylamide, hydroxyethyl methacrylate (HEMA), glycidyl methacrylate, dihydroxypropyl methacrylate, vinyl acetate/butyl acrylate/2-ethylhexyl acrylate, vinyl acetate/butyl maleate, vinyl acetate/ethylene, vinyl acetate/vinyl chloride/butyl acrylate and vinyl acetate/vinyl chloride/ethylene, or mixtures thereof.

Examples of homopolymers of C₂-C₄₀ alpha-olefins include, but are not limited to, ethylene, isobutylene, octene, nonene, styrene or mixtures thereof. Examples of diene polymers include, but are not limited to, copolymers of butadiene with one or more of styrene, vinyl toluene, acrylonitrile, methacrylonitrile, and esters of acrylic acid or methacrylic acid, or mixtures thereof.

The liquid composition preferably comprises
0.02 to 17.00 weight-% of the associative thickener,
0.01 to 28.00 weight-% of the anionic surfactant,
55.00 to 99.97 weight-% of the binder resin,
calculated on the total weight of the associative thickener, the anionic surfactant, and the binder.

More preferably, the liquid composition comprises
0.08 to 12.00 weight-% of the associative thickener,
0.03 to 20.00 weight-% of the anionic surfactant,
68.00 to 99.89 weight-% of the binder resin,
calculated on the total weight of the associative thickener, the anionic surfactant, and the binder.

Even more preferably the liquid composition preferably comprises
0.15 to 7.00 weight-% of the associative thickener,
0.06 to 12.00 weight-% of the anionic surfactant,
81.00 to 99.79 weight-% of the binder,
calculated on the total weight of the associative thickener, the anionic surfactant, and the binder.

The liquid composition most preferably comprises
0.25 to 3.50 weight-% of the associative thickener,
0.10 to 3.50 weight-% of the anionic surfactant,
93.00 to 99.65 weight-% of the binder resin,
calculated on the total weight of the associative thickener, the anionic surfactant, and the binder.

The liquid composition suitably may include one or more pigments and/or one or more pigment compositions or pigments concentrates. The term “pigment,” refers to a substance that imparts color to another substance or mixture. Pigments are usually present in the form of organic or inorganic dry powders. A “pigment composition”, “pigment paste” or “pigment concentrate” is also a substance that imparts color to another substance or mixture, and generally includes at least one pigment and other additives. Dry pigments may be insoluble in organic solvents and water, which can necessitate wetting, disaggregation and deagglomeration before dispersion can take place and enable the production of a stable, colloidal pigmentary dispersion in the paint formulation.

The liquid composition may suitably include one or more pigments and/or one or more pigment compositions. Pigment compositions may include white opacifying pigments and/or colored pigments. Colored pigments include organic pigments and inorganic pigments.

Pigment compositions, also called pigment pastes, preferably include wetting agents, dispersing agents, polyethers, water, neutralizing agent, defoaming agents, preservatives, etc. The classes of compounds encompassed by the polyether include polyalkylene glycols, such as low to moderate molecular weight polyethylene and polypropylene glycols; polyhydroxy ethers, such as those formed from epoxide polymerization; polysaccharide compounds, such as polysorbitan and polysorbitol; and polyalkylene oxides, such as polyethylene and polypropylene oxide.

White opacifying pigments include, but are not limited to, rutile and anatase titanium dioxides, lithopone, zinc sulfide, lead titanate, antimony oxide, zirconium oxide, barium sulfide, white lead, zinc oxide, leaded zinc oxide, and the like, and mixtures thereof. In some embodiments, an average particle size of the opacifying pigments ranges between 0.2 to 0.4 microns.

Black pigments include, but are not limited to, various carbon blacks (Pigment Black 7), channel blacks, furnace blacks, lampblacks, or mixtures thereof.

The pigment may also be chosen from a wide range of conventional colored pigments. The colored pigment can be blue, black, brown, cyan, green, white, violet, magenta, red, orange, yellow, or mixtures thereof. Suitable classes of colored pigments include, for example, anthraquinones, phthalocyanine blues, phthalocyanine greens, diazos, monoazos, pyranthrones, perylenes, heterocyclic yellows, quinacridones, and (thio)indigoids. Representative examples of phthalocyanine blues include, but not limited to, copper phthalocyanine blue and derivatives thereof (Pigment Blue 15).

Examples of quinacridones include, but are not limited to, Pigment Orange 48, Pigment Orange 49, Ironoxide Red, Pigment Red 122, Pigment Red 192, Pigment Red 202, Pigment Red 206, Pigment Red 207, Pigment Red 209, Pigment Violet 19 and Pigment Violet 42. Examples of anthraquinones include, but are not limited to, Pigment Red 43, Pigment Red 194 (Perinone Red), Pigment Red 216 (Brominated Pyranthrone Red) and Pigment Red 226 (Pyranthrone Red). Examples of perylenes include, but are not limited to, Pigment Red 123 (Vermillion), Pigment Red 149 (Scarlet), Pigment Red 179 (Maroon), Pigment Red 190 (Red), Pigment Violet 19, Pigment Red 189 (Yellow Shade Red) and Pigment Red 224. Examples of thioindigoids include, but are not limited to, Pigment Red 86, Pigment Red 87, Pigment Red 88, Pigment Red 181, Pigment Red 198, Pigment Violet 36, and Pigment Violet 38. Examples of heterocyclic yellows include, but are not limited to, Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 151, Pigment Yellow 117, Pigment Yellow 128 and Pigment Yellow 138. Such pigments are commercially available in either powder or press cake from a number of sources.

Other examples of pigments include, but are not limited to, Hostafine® Yellow GR (Pigment 13), Hostafine® Yellow (Pigment 83), Hostafine® Red FRLL (Pigment Red 9), Hostafine® Rubine F6B (Pigment 184), Hostafine® Blue 2G (Pigment Blue 15:3), Hostafine® Black T (Pigment Black 7), and Hostafine® Black TS (Pigment Black 7), Normandy Magenta RD-2400, Paliogen Violet 5100, Paliogen® Violet 5890, Permanent Violet VT2645, Heliogen® Green L8730, Argyle Green XP-111-S, Brilliant Green Toner GR 0991, Heliogen® Blue L6900, L7020, Heliogen® Blue D6840, D7080, Heliogen® Blue L7101 F, Sudan Blue OS, PV Fast Blue B2GO1, Irgalite Blue BCA, Paliogen® Blue 6470, Sudan III, Sudan II, Sudan IV, Sudan Orange G, Sudan Orange 220, Paliogen® Orange 3040, Ortho Orange OR 2673, Paliogen® Yellow 152, 1560, Lithol Fast Yellow 0991K, Paliotol Yellow 1840, Novoperm® Yellow FG 1, Permanent Yellow YE 0305, Lumogen Yellow D0790, Suco-Gelb L1250, Suco-Yellow D1355, Hostaperm® Pink E, Fanal Pink D4830, Cinquasia Magenta, Lithol Scarlet D3700, Toluidine Red, Scarlet for Thermoplast NSD PS PA, E.D. Toluidine Red, Lithol Rubine Toner, Lithol Scarlet 4440, Bon Red C, Royal Brilliant Red RD-8192, Oracet Pink RF, Paliogen® Red 3871K, Paliogen® Red 3340, and Lithol Fast Scarlet L4300.

In some embodiments, the waterborne coating composition is a paint composition. Paint compositions may be prepared by mixing a base composition with one or more pigment compositions. A base composition may include other components such as water, polyglycol, a latex resin, dispersant, defoamer, a preservative, one or more opacifying pigments, a binder, a coalescing agent, and the thickener composition of the invention.

An amount of the thickener composition in the paint may suitably range from 0.001 g to 0.060 g, from 0.003 g to 0.040 g, or from 0.005 g to 0.020 g per gram of base paint, i. e., paint before adding tinting material.

The order of mixing the ingredients is done using methods known in the paint industry. For example, a grind formulation and a let down formulation may be prepared. The grind formulation may include water, propylene glycol, cellulosic thickener, dispersants, defoamer, preservative, and TiO₂. The grind formulation may be mixed and ground to disperse the TiO₂ in the formulation. The let down formulation may include resin, an opaque polymer, a coalescing compound, associative thickener, and/or a defoamer. The let down formulation may be added to the grind formulation to form a neutral colored paint formulation. A pigment and/or pigment composition may be added to the neutral colored paint formulation (base composition) prior to painting and/or at the point of sale of the paint. One or more pigment compositions may be added to the base composition to impart color to the paint.

The associative thickener described herein may also be used for improving the viscosity stability of other aqueous systems that do not contain a latex, such as cosmetics, hair dyes, aqueous-based cutting oils, drilling fluids and fluids used in gas and oil production, packer fluids, cleaners, liquid detergents and fabric softeners, pesticide and agricultural compositions, personal care products (including shampoos, hair conditioners, hand lotions, hand creams, astringents, depilatories, and antiperspirants) and pharmaceutical formulations.

A further object of the invention is to provide an article, wherein at least a part of the surface of the article is coated with the liquid composition. In a different embodiment, the coated article is obtainable by the steps of providing an article, providing the liquid composition according to the present invention and coating at least a part of the surface of the article with the liquid composition.

In a further embodiment, the invention also relates to a process for improving the tinting viscosity stability of a liquid composition comprising the steps of providing a liquid composition comprising a binder, adding the thickener composition according to the invention, mixing, adding one or more pigments and/or pigment compositions, and mixing. Suitable liquid compositions are the liquid compositions as aforementioned amongst others. The step of mixing the components may be executed according to current processes known by the person skilled in the art. This may involve mixing by manual or electrical means inter alia. Mixing is combining the compositions and exerting shear force on the combined compositions.

The invention additionally deals with the use of the thickener composition according to the invention for improving the tinting viscosity stability of a pigmented liquid composition.

The invention is illustrated further below giving reference to examples. The choice of the respective reaction conditions, as e. g., the reaction temperature, reaction time, and dosing rates are known to the skilled person and are illustrated in more detail in the working examples.

### EXPERIMENTAL PART

### Abbreviations

EO: ethylene oxide
PO: propylene oxide
IPDI: isophorone diisocyanate
TMDI: 2,2,4(or 2,4,4)-trimethyl-1,6-diisocyanatohexane
H12MDI: 4,4′-methylene bis(isocyanatocyclohexane)
TMXDI: 1,3-bis(2-isocyanatopropan-2-yl)benzene
PEG: polyethylene glycol

### Formulation of the Thickener Composition

General description of the preparation of thickener compositions: Water, sodium bicarbonate, biocide and surfactants are filled into a glass bottle. The mixture is heated and stirred until everything is well dissolved. The associative thickener (polyurethane) is added and dissolved under heating and stirring. For amounts employed in specific examples see Table 4,

TABLE 1
Anionic surfactants

| Anionic surfactant | chemical description |
|---|---|
| AS 1 | sodium laurylether sulfate (12 EO) |
| AS 2 | sodium C10C13-alkylbenzene sulfonate |
| AS 3 | sodium lauryl sulfate |
| AS 4 | sodium isotridecylether sulfate (20 EO) |
| AS 5 | sodium laurylether sulfate (1 EO) |
| AS 6 | ammonium laurylether sulfate (3 EO) |
| AS 7 | sodium laurylether sulfate (4 EO) |
| AS 8 | sodium laurylether sulfate (30 EO) |

TABLE 2
Nonionic surfactants

| Nonionic surfactant | chemical description |
|---|---|
| NS 1 | ethyleneoxide-propyleneoxide-copolymer |
| | monobutyl ether (Mw = 520 g/mol) |
| NS 2 | C8-C16-alkylpolyglycoside |
| NS 3 | polyethylenglycol-block-polypropylenegylcol- |
| | block-polyethyleneglycol, 30% EO, M (from |
| | OH-value) = ca. 1750 g/mol |
| NS 4 | ethyleneglycol-propylenegylcol-copolymer |
| | (random copolymer) monobutyl ether, EO:PO |
| | ratio = 1:1, Mw = ca. 2200 g/mol |
| NS 5 | Mixture of C10-C16-alkylpolyglycoside and |
| | C8-C10-alkyl polyglycoside (1:2.4) |

TABLE 3
Associative thickeners

| Associative | |
|---|---|
| thickener | |
| (polyurethane) | description |
| PU 1 | Polyurethane made from PEG 8000, tristyrylphenol |
| | ethoxylate, IPDI-Trimer; Example 2 in U.S. Pat. |
| | No. 78,681,522 B2 |
| PU 2 | Polyurethane made from pentaerythritol propoxylate/ |
| | ethoxylate (80% EO/20% PO) and octadecylisocyanate |
| | in a molar ratio of 1:3 |
| PU 3 | Polyurethane made from PEG 8000, 1-dodecanol, |
| | TMXDI in a molar ratio of 2:2:3 |

TABLE 4
Thickener compositions (all amounts in weight-%)

| Exp. | AS | AS | NS | NS | NS | NS | NS | PU | PU | PU | | | |
|---|---|---|---|---|---|---|---|---|---|---|---|---|---|
| No. | type | amount | 1 | 2 | 3 | 4 | 5 | 1 | 2 | 3 | Water | NaHCO₃ | Biocide |
| NE 1 | — | — | 22.5 | | | | | 15.0 | | | 62.3 | 0.1 | 0.1 |
| IE 1 | AS 1 | 7.7 | 15.8 | | | | | 15.0 | | | 60.9 | 0.1 | 0.5 |
| IE 2 | AS 2 | 14.2 | 15.8 | | | | | 15.0 | | | 54.4 | 0.1 | 0.5 |
| IE 3 | AS 3 | 25.7 | 15.8 | | | | | 15.0 | | | 42.9 | 0.1 | 0.5 |
| IE 4 | AS 4 | 7.5 | 15.8 | | | | | 15.0 | | | 61.1 | 0.1 | 0.5 |
| IE 5 | AS 5 | 18.0 | 15.8 | | | | | 15.0 | | | 50.6 | 0.1 | 0.5 |
| IE 6 | AS 1 | 6.0 | 18.0 | | | | | 12.0 | | | 63.8 | 0.1 | 0.1 |
| NE 2 | — | — | | 11.7 | | | | 15.0 | | | 73.1 | 0.1 | 0.1 |
| NE 3 | — | — | | | 22.5 | | | 15.0 | | | 62.3 | 0.1 | 0.1 |
| NE 4 | — | — | | | | 22.5 | | 15.0 | | | 62.3 | 0.1 | 0.1 |
| IE 7 | AS 1 | 7.7 | | 8.2 | | | | 15.0 | | | 68.6 | 0.1 | 0.4 |
| IE 8 | AS 1 | 7.7 | | | 15.8 | | | 15.0 | | | 61.0 | 0.1 | 0.4 |
| IE 9 | AS 1 | 7.7 | | | | 15.8 | | 15.0 | | | 61.0 | 0.1 | 0.4 |
| IE 10 | AS 6 | 2.2 | 21.7 | | | | | 14.5 | | | 61.5 | 0.1 | 0.1 |
| IE 11 | AS 6 | 6.0 | 20.2 | | | | | 13.5 | | | 60.1 | 0.1 | 0.1 |
| IE 12 | AS 6 | 9.4 | 18.9 | | | | | 12.6 | | | 58.9 | 0.1 | 0.1 |
| IE 13 | AS 1 | 1.1 | 21.7 | | | | | 14.5 | | | 62.5 | 0.1 | 0.1 |
| IE 14 | AS 1 | 3.1 | 20.2 | | | | | 13.5 | | | 63.1 | 0.1 | 0.1 |
| IE 15 | AS 1 | 4.8 | 18.9 | | | | | 12.6 | | | 63.5 | 0.1 | 0.1 |
| IE 16 | AS 1 | 6.1 | 17.9 | | | | | 11.9 | | | 63.9 | 0.1 | 0.1 |
| IE 17 | AS 7 | 1.1 | 21.7 | | | | | 14.5 | | | 62.6 | 0.1 | 0.1 |
| IE 18 | AS 7 | 3.0 | 20.2 | | | | | 13.5 | | | 63.2 | 0.1 | 0.1 |
| IE 19 | AS 7 | 4.6 | 18.9 | | | | | 12.6 | | | 63.7 | 0.1 | 0.1 |
| IE 20 | AS 8 | 1.2 | 21.7 | | | | | 14.5 | | | 62.5 | 0.1 | 0.1 |
| IE 21 | AS 8 | 5.1 | 18.9 | | | | | 12.6 | | | 63.2 | 0.1 | 0.1 |
| IE 22 | AS 8 | 3.3 | 20.2 | | | | | 13.5 | | | 62.8 | 0.1 | 0.1 |
| NE 5 | — | — | | | 12.8 | | 3.8 | | 20.0 | | 62.8 | 0.0 | 0.6 |
| NE 6 | AS 1 | 7.5 | | | 9.6 | | 2.9 | | 15.0 | | 64.5 | 0.0 | 0.5 |
| NE 7 | — | — | | | | 20.0 | | | | 20.0 | 59.4 | 0.1 | 0.5 |
| NE 8 | AS 1 | 7.5 | | | | 15.0 | | | | 15.0 | 62.0 | 0.1 | 0.4 |

TABLE 5
Raw materials

| Name | Description | Manufacturer |
|---|---|---|
| Acronal DS 6262 | Acrylic dispersion | BASF SE |
| Acticide MBS | Biocide based on methylisothiazolinone, | Thor GmbH |
| | benzisothiazolinone | |
| DISPERBYK-199 | VOC-free wetting and dispersing additive | BYK-Chemie GmbH |
| BYK-1640 | VOC- and silicone-free defoamer | BYK-Chemie GmbH |
| Kronos 2190 | Titaniumdioxide | Kronos Titan GmbH |
| RHEOBYK-7420 ES | Solution of a modified urea | BYK-Chemie GmbH |
| Texanol | 2,2,4-Trimethyl-1,3- | Eastman |
| | pentandiolmonoisobutyrat | |
| BYK-093 | Foam destroying polysiloxanes and | BYK-Chemie GmbH |
| | hydrophobic solids in polyglycol | |
| BYKETOL-PC | Preparation of a modified urea | BYK-Chemie GmbH |
| OPTIGEL WX | Activated phyllosilicate | BYK-Chemie GmbH |
| Bayferrox 120M | iron oxide red pigment | LANXESS Deutschland |
| | | GmbH |
| DISPERBYK-2061 | VOC-free wetting and dispersing additive | BYK-Chemie GmbH |
| Blanc Fixe micro | Barium sulfate | Sachtleben Pigment |
| | | GmbH |
| Heliogen Green L | chromatic phthalocyanine green pigment | Sun Chemical GmbH |
| 8730 | | |
| Heliogen blue L | phthalocyanine blue pigment | Sun Chemical GmbH |
| 7101F | | |

### Test 1: Incorporation and Compatibility

TABLE 6
Water-based acrylic white paint

| Mill base: | |
|---|---|
| Water | 4.5 |
| Acticide MBS | 0.2 |
| DISPERBYK-199 | 1.1 |
| BYK-1640 | 0.3 |
| Kronos 2190 | 22.5 |
| RHEOBYK-7420 ES | 0.3 |
| Water | 5.0 |
| Dissolver 20 min with 12 m/s at RT, toothed plate | |
| Let down: | |
| Acronal DS 6262 | 57.0 |
| Texanol | 1.5 |
| BYK-093 | 0.3 |
| Water | 7.3 |
| | 100.0 |

Production of the water-based acrylic white paint was carried out using the formulation in table 6. All given amounts are in weight-%. After production the white paint was divided in smaller amounts (50 g in 175 ml PE beaker) and the inventive and non-inventive samples were incorporated with a dosage of 0.15% of the respective associative thickener (polyurethane) (calculated on the total lacquer) (see table 6). The samples were added with a pipette under stirring conditions with a Dispermat LC3 (VMA Getzmann) at 1000 rpm with a 2.5 cm diameter toothed plate. The stirring time was 5-15 minutes at room temperature (23° C.) until the samples were optically homogeneous. During the incorporation of the products, it was evaluated whether the additive was easy to dose by dropping into the paint via a pipette or whether dosing was difficult, because threads formed during dosing via pipette. After storage at room temperature (RT) over night the samples were applied with a frame film applicator (BYK-Gardner GmbH) with 120 μm wet film thickness on Bykochart 2851 (BYK-Gardner GmbH) and dried 1 day at room temperature. As a criterion for compatibility/workability the seeding tendency was visually evaluated with a range from 1-5 (no—strong seeds). Seeding describes the appearance of collections of particles significantly larger than the thickness of the dry paint film.

TABLE 7
Results

| Group of | | Necessary | | |
|---|---|---|---|---|
| corresponding | | incorporation | Threads | |
| examples | Sample | time [min] | formed | Seeds |
| I | NE 1 | 15 | yes | 4 |
| | IE 1 | 5 | no | 1-2 |
| | IE 2 | 5 | no | 1 |
| | IE 3 | 5 | no | 1 |
| | IE 4 | 5 | no | 1 |
| | IE 5 | 5 | no | 1 |
| | IE 6 | 5 | no | 2 |
| II | NE 2 | 5 | yes | 2-3 |
| | IE 7 | 5 | yes | 1-2 |
| III | NE 3 | 5 | yes | 5 |
| | IE 8 | 5 | slight | 2 |
| IV | NE 4 | 5 | yes | 4 |
| | IE 9 | 5 | yes | 1-2 |

It was surprisingly found that the inventive examples IE 1-IE 6 required significantly less incorporation time to yield a visually homogenous formulation, and lead to less seeds and thread forming than the comparative non-inventive example NE1; the inventive example IE 7 causes significant less seeds in the final paint film than the comparable non-inventive example NE 2; the inventive example IE 8 causes less seeds and less threads than the comparable non-inventive example NE 3; the inventive example IE 9 causes less seeds than the comparable non-inventive example NE 4 (see Table 7).

Test 2: Viscosity Stability Due to Tinting with Iron Oxide Red Pigment Concentrate

Production of the water-based acrylic white paint was carried out using the formulation in table 8. All given amounts are in weight-%. After production the white paint was divided in smaller amounts (50 g in 175 ml PE beaker) and the inventive and non-inventive samples were incorporated with a dosage of 0.15% of the associative thickener (polyurethane) (calculated on the total lacquer) (see table 8). The inventive samples were added with a pipette under stirring conditions with a Dispermat LC3 (VMA Getzmann) at 1000 rpm with a 2.5 cm diameter toothed plate. The stirring time was 5-15 minutes at room temperature (23° C.) until the samples were optically homogeneous. After 1 day at room temperature, the viscosity of the white paint was measured in a controlled shear rate measurement with a rheometer MCR-301 (Anton Paar GmbH) at a shear rate of 1 s⁻¹. Production of the red iron oxide pigment concentrate was carried out using the formulation in table 9. Tinting of the white paint with the iron oxide pigment concentrate was carried out using a weight ratio of 95:5. After storage at room temperature over night, the viscosity of the tinted paint was measured again.

To determine the change in viscosity due to tinting, the difference in viscosity between white lacquer and tinted lacquer is calculated and the percentage change compared to the initial viscosity of the white lacquer is given in table 10.

TABLE 8
Water-based acrylic white paint

| Mill base: | |
|---|---|
| Water | 4.5 |
| Acticide MBS | 0.2 |
| DISPERBYK-199 | 1.1 |
| BYK-1640 | 0.3 |
| Kronos 2190 | 22.5 |
| RHEOBYK-7420 ES | 0.3 |
| Water | 5.0 |
| Dissolver 20 min with 12 m/s at RT, toothed plate | |
| Let down: | |
| Acronal DS 6262 | 57.0 |
| Texanol | 1.5 |
| BYK-093 | 0.3 |
| Water | 7.3 |
| | 100.0 |

TABLE 9
Water-based iron oxide red pigment concentrate

| Water | 8.8 |
|---|---|
| BYKETOL-PC | 15.0 |
| Acticide MBS | 0.1 |
| BYK-1640 | 0.4 |
| DISPERBYK-199 | 8.2 |
| Optigel WX | 0.4 |
| Bayferrox 120M | 65.0 |
| Dissolver 20 min with 12 m/s at RT, toothed plate | |
| BYK-1640 | 0.2 |
| Water | 2.0 |
| | 100.0 |

TABLE 10
Results

| | | Viscosity | Viscosity | |
|---|---|---|---|---|
| Group of | | white paint | red tinted | Viscosity |
| corresponding | | at 1 1/s | paint at 1 1/s | change/ |
| examples | Sample | [Pa s] | [Pa s] | % |
| I | NE 1 | 34.70 | 30.60 | 11.8 |
| | IE 1 | 33.10 | 32.30 | 2.5 |
| | IE 3 | 28.00 | 25.70 | 8.2 |
| | IE 4 | 37.00 | 39.00 | 5.4 |
| | IE 5 | 33.30 | 34.40 | 3.3 |
| | IE 6 | 31.70 | 32.70 | 3.2 |
| | IE 10 | 32.55 | 34.79 | 6.9 |
| | IE 11 | 34.60 | 35.10 | 1.5 |
| | IE 12 | 33.64 | 36.74 | 9.2 |
| | IE 13 | 33.09 | 35.22 | 6.4 |
| | IE 14 | 35.18 | 37.63 | 7.0 |
| | IE 15 | 36.25 | 36.21 | 0.1 |
| | IE 16 | 30.72 | 32.54 | 5.9 |
| | IE 17 | 39.35 | 42.63 | 8.3 |
| | IE 18 | 38.18 | 40.38 | 5.8 |
| | IE 19 | 37.68 | 38.87 | 3.2 |
| | IE 20 | 29.98 | 32.86 | 9.6 |
| | IE 21 | 33.47 | 30.31 | 9.4 |
| II | NE 4 | 31.30 | 42.40 | 35.5 |
| | IE 9 | 34.30 | 43.10 | 25.7 |

As illustrated in table 10 it was surprisingly found that the inventive examples IE 1, IE 3-IE 6, IE 10-21 cause a better viscosity stability upon tinting with iron oxide red pigment concentrate than the non-inventive comparable example NE 1, which does not contain an anionic surfactant. Likewise, the inventive example IE 9 causes a better viscosity stability upon tinting with iron oxide red pigment concentrate than the respective non-inventive examples NE 4, which does not contain an anionic surfactant.

Test 3: Viscosity Stability Due to Tinting with Green Pigment Concentrate

Production of the water-based acrylic white paint was carried out using the formulation in table 11. All given amounts are weight-%. After production the white paint was divided in smaller amounts (50 g in 175 ml PE beaker) and the inventive and non-inventive samples were incorporated with a dosage of 0.15% of the associative thickener (polyurethane) (calculated on the total lacquer) (see table 4). The samples were added with a pipette under stirring conditions with a Dispermat LC3 (VMA Getzmann) at 1000 rpm with a 2.5 cm diameter toothed plate. The stirring time was 5-15 minutes at room temperature (23° C.) until the samples were optically homogeneous. After 1 day at room temperature, the viscosity of the white paint was measured in a controlled shear rate measurement with a rheometer MCR-301 (Anton Paar GmbH) at 1 s⁻¹ at 23° C. with a 2.5 cm 1° cone. Production of the green pigment concentrate was achieved using the formulation in table 12. Tinting of the white paint with the green pigment concentrate was carried out in a weight ratio of 95:5. After storage at room temperature over night, the viscosity of the tinted paint was measured again. To determine the change in viscosity due to tinting, the difference in viscosity between white lacquer and tinted lacquer was calculated and the percentage change compared to the initial viscosity of the white lacquer is given in table 13.

TABLE 11
Water-based acrylic white paint

| Mill base: | |
|---|---|
| Water | 4.5 |
| Acticide MBS | 0.2 |
| DISPERBYK-199 | 1.1 |
| BYK-1640 | 0.3 |
| Kronos 2190 | 22.5 |
| RHEOBYK-7420 ES | 0.3 |
| Water | 5.0 |
| Dissolver 20 min with 12 m/s at RT, toothed plate | |
| Let down: | |
| Acronal DS 6262 | 57.0 |
| Texanol | 1.5 |
| BYK-093 | 0.3 |
| Water | 7.3 |
| | 100.0 |

TABLE 12
Water-based green pigment concentrate

| Water | 35.0 |
|---|---|
| Acticide MBS | 0.1 |
| BYK-1640 | 0.4 |
| DISPERBYK-2061 | 6.0 |
| Optigel WX | 0.5 |
| Blanc Fixe micro | 10.0 |
| Heliogen green L 8730 | 40.0 |
| Dispermat CV 1 h with 8000 rpm at 20° C. | |
| glass beads:mill base 1:1, Teflon plate | |
| BYK-1640 | 0.2 |
| Water | 7.8 |
| | 100.0 |

TABLE 13
Results

| | | Viscosity | Viscosity | |
|---|---|---|---|---|
| Group of | | white paint | green tinted | Viscosity |
| corresponding | | at 1 1/s | paint at 1 1/s | change |
| examples | Sample | [Pa s] | [Pa s] | % |
| I | NE 1 | 33.4 | 25.8 | 22.8 |
| | IE 1 | 33.1 | 27.9 | 15.7 |
| | IE 2 | 23.6 | 24.3 | 3.0 |
| | IE 6 | 31.7 | 26.5 | 16.5 |
| II | NE 5 | 17.9 | 12.8 | 28.5 |
| | NE 6 | 24.7 | 17.5 | 29.1 |

As shown in table 13, it was surprisingly found that the inventive examples IE 1, IE 2 and IE 6 lead to a reduced viscosity loss upon tinting, thereby providing better viscosity stability upon pigment addition with a Heliogen green pigment concentrate than the corresponding non-inventive example NE 1, which does not contain an anionic surfactant. In the case of non-inventive example NE 5, containing an associative thickener, which is structurally different from the associative thickener of the invention, the addition of an anionic surfactant (NE 6) does not mitigate the loss of tinting viscosity stability.

Test 4: Viscosity Stability Due to Tinting with Blue Pigment Concentrate

Production of the water-based acrylic white paint was carried out using the formulation in table 14. All given amounts are in weight-%. After production the white paint was divided in smaller amounts (50 g in 175 ml PE beaker) and the inventive and non-inventive samples were incorporated with a dosage of 0.15% of the associative thickener (polyurethane) (calculated on the total lacquer) (see table 4). The samples were added with a pipette under stirring conditions with a Dispermat LC3 (VMA Getzmann) at 1000 rpm with a 2.5 cm diameter toothed plate. The stirring time was 5-15 minutes at room temperature (23° C.) until the samples were optically homogeneous. After 1 day at room temperature, the viscosity of the white paint was measured in a controlled shear rate measurement with a rheometer MCR-301 (Anton Paar GmbH) at 1 s⁻¹ at 23° C. with a 2.5 cm 1° cone. Production of the blue pigment concentrate was carried out using the formulation in table 15. Tinting of the white paint with the blue pigment concentrate was carried out using a weight ratio of 95:5. After storage at room temperature over night, the viscosity of the tinted paint was measured again. To determine the change in viscosity due to tinting, the difference in viscosity between white lacquer and tinted lacquer was calculated and the percentage change compared to the initial viscosity of the white lacquer is given in table 16.

TABLE 14
Water-based acrylic white paint

| Mill base: | |
|---|---|
| Water | 4.5 |
| Acticide MBS | 0.2 |
| DISPERBYK-199 | 1.1 |
| BYK-1640 | 0.3 |
| Kronos 2190 | 22.5 |
| RHEOBYK-7420 ES | 0.3 |
| Water | 5.0 |
| Dissolver 20 min with 12 m/s at RT, toothed plate | |
| Let down: | |
| Acronal DS 6262 | 57.0 |
| Texanol | 1.5 |
| BYK-093 | 0.3 |
| Water | 7.3 |
| | 100.0 |

TABLE 15
Water-based blue pigment concentrate

| Water | 22.00 |
|---|---|
| Acticide MBS | 0.10 |
| BYK-1640 | 0.40 |
| DISPERBYK-199 | 26.30 |
| Optigel WX | 0.35 |
| Blanc Fixe micro | 10.00 |
| Heliogen blue L 7101F | 35.00 |
| Dispermat CV 1 h at 8000 rpm, glass beads:mill 1:1 | |
| BYK-1640 | 0.20 |
| Water | 5.65 |
| | 100.00 |

TABLE 16
Results

| | Viscosity | Viscosity | |
|---|---|---|---|
| | white paint | blue tinted | Viscosity |
| | at 1 1/s | paint at 1 1/s | change |
| Sample | [Pa s] | [Pa s] | % |
| NE 1 | 16.9 | 23.1 | 37.5 |
| IE 10 | 32.6 | 29.0 | 11.0 |
| IE 11 | 34.6 | 33.5 | 3.3 |
| IE 12 | 33.6 | 33.1 | 1.8 |
| IE 13 | 33.1 | 30.5 | 7.7 |
| IE 14 | 35.2 | 26.5 | 24.7 |
| IE 15 | 36.3 | 28.6 | 21.2 |
| IE 17 | 39.4 | 34.4 | 12.6 |
| IE 18 | 38.2 | 29.3 | 23.2 |
| IE 19 | 37.7 | 30.2 | 19.9 |
| IE 20 | 30.0 | 27.2 | 9.3 |
| IE 21 | 33.5 | 24.2 | 27.6 |
| IE 22 | 23.3 | 22.5 | 3.7 |

As illustrated in table 16 it was surprisingly found that the inventive examples IE 10-IE 15 and IE 17-IE 22 cause a better viscosity stability upon tinting with blue pigment concentrate than the comparable non-inventive example NE 1, which does not contain an anionic surfactant.

### Test 5: Influence on Gloss and Color Stability

Production of the water-based acrylic white paint was carried out using the formulation in table 17. All given amounts are in weight-%. After production the white paint was divided in smaller amounts (50 g in 175 ml PE beaker) and the inventive and non-inventive samples were incorporated with a dosage of 0.15% of the associative thickener (polyurethane) (calculated on the total lacquer) (see table 4). The samples were added with a pipette under stirring conditions with a Dispermat LC3 (VMA Getzmann) at 1000 rpm with a 2.5 cm diameter toothed plate. The stirring time was 5-15 minutes at room temperature (23° C.) until the samples were optically homogeneous. Production of the red iron oxide pigment concentrate was carried out using the formulation in table 18. Tinting of the white paint with the iron oxide pigment concentrate was carried out using a weight ratio of 95:5. After tinting the paint was applied on Bykochart 2851 (BYK-Gardner GmbH) with a 150 μm bar shaped film applicator (BYK-Gardner GmbH). During drying a typical rub out test was performed where the paint was rubbed out with the finger until the viscosity of the paint increased noticeably so that the pigments could no longer float out. After drying the gloss at 20° was measured with a micro-Tri-gloss (BYK-Gardner GmbH), and for the color difference between rubbed out and non-rubbed out draw down, the Delta E, was measured with a color-guide (BYK-Gardner GmbH). In each case, triple measurements were performed, and the average values were calculated.

TABLE 17
Water-based acrylic white paint

| Mill base: | |
|---|---|
| Water | 4.5 |
| Acticide MBS | 0.2 |
| DISPERBYK-199 | 1.1 |
| BYK-1640 | 0.3 |
| Kronos 2190 | 22.5 |
| RHEOBYK-7420 ES | 0.3 |
| Water | 5.0 |
| Dissolver 20 min with 12 m/s at RT, toothed plate | |
| Let down: | |
| Acronal DS 6262 | 57.0 |
| Texanol | 1.5 |
| BYK-093 | 0.3 |
| Water | 7.3 |
| | 100.0 |

TABLE 18
Water-based pigment concentrate iron oxide red

| Water | 8.8 |
|---|---|
| BYKETOL-PC | 15.0 |
| Acticide MBS | 0.1 |
| BYK-1640 | 0.4 |
| DISPERBYK-199 | 8.2 |
| Optigel WX | 0.4 |
| Bayferrox 120M | 65.0 |
| Dissolver 20 min with 12 m/s at RT, toothed plate | |
| BYK-1640 | 0.2 |
| Water | 2.0 |
| | 100.0 |

TABLE 19
Results

| Group of corresponding examples | Sample | Gloss 20° | Delta E |
|---|---|---|---|
| I | NE 1 | 34.5 | 0.76 |
| | IE 1 | 36.2 | 0.19 |
| | IE 2 | 38.4 | 0.64 |
| | IE 3 | 38.8 | 0.65 |
| | IE 4 | 41.0 | 0.27 |
| | IE 5 | 35.8 | 0.19 |
| II | NE 4 | 31.0 | 1.09 |
| | IE 9 | 35.3 | 0.47 |
| III | NE 7 | 30.7 | 1.01 |
| | NE 8 | 25.3 | 1.42 |

As shown in table 19 it was surprisingly found that the inventive examples IE 1-IE 5 lead to a higher gloss and a lower color difference in the application system than the respective non-inventive example NE 1. The same is observable with inventive example IE 9 in comparison to the respective non-inventive example NE 4. The non-inventive example NE 7, that contains a non-inventive associative thickener, causes worse results than NE 1 and the performance cannot be improved by the addition of an anionic surfactant (NE 8), but the opposite effect is observed.

1. A thickener composition comprising at least one anionic surfactant, and
at least one associative thickener, wherein the associative thickener comprises
at least one polyether segment, and
at least one hydrophobic segment according to formula (I) 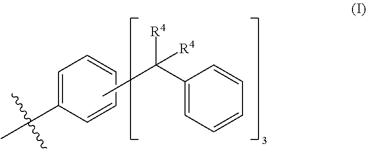
wherein R⁴ is independent of each occurrence hydrogen, alkyl, cycloalkyl, aryl or arylalkyl, and wherein the at least one associative thickener comprises at least one of a HEUR and a HEAT thickener.

2. The thickener composition according to claim 1, wherein the associative thickener is an associative thickener according to formula (II) 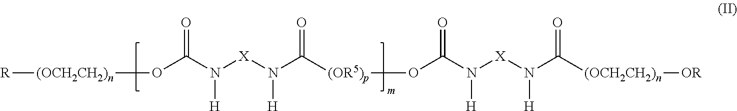
wherein R is at least one of a hydrophobic segment according to formula (I) and an aliphatic or cycloaliphatic group with 7 to 20 carbon atoms, with the proviso that at least one R is a hydrophobic segment according to formula (I); m is ≥1; n independent of each other is ≥0; p ranges from 45 to 500; R⁵ is selected from C₂H₄ and C₃H₆ with the proviso that at least 70 mole % of R⁵ is represented by C₂H₄; and X is independent of each occurrence 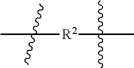
where R² is aliphatic, cycloaliphatic, or aromatic;
or X is 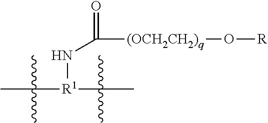
where q is ≥0, R is as defined above, and where R¹ is: 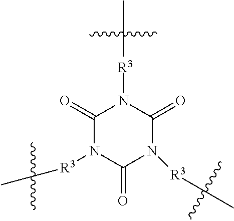
where R³ is aliphatic, cycloaliphatic, or aromatic.

3. The thickener composition according to claim 1, wherein the at least one associative thickener has a number average molecular weight Mn in the range of 4000 g/mol to 80000 g/mol.

4. The thickener composition according to claim 1, wherein the anionic surfactant comprises at least one of an alkyl ether sulfate, aryl ether sulfate, alkyl sulfate, aryl sulfate, and dialkylsulfosuccinate.

5. The thickener composition according to claim 1, wherein the anionic surfactant comprises at least one of tristyrylphenol ether sulfate, ammonium laureth sulfate, sodium laureth sulfate, sodium lauryl ether sulfate, ammonium lauryl ether sulfate, sodium alkylbenzene sulfonate, sodium isotridecyl ethersulfate.

6. The thickener composition according to claim 1, wherein the weight ratio of the associative thickener and the at least one anionic surfactant is in the range from 19:1 to 7:13, calculated on the total weight of the associative thickener and the anionic surfactant.

7. The thickener composition according to claim 1, wherein the thickener composition comprises at least one of a non-ionic surfactant.

8. The thickener composition according to claim 7 wherein the at least one non-ionic surfactant comprises at least one of a polyalkylene glycol monoalkyl ether, a polyalkylene glycol, an alkylpolyglycoside,

9. The thickener composition according to claim 1, wherein the thickener composition comprises between 0 and 95% of water, calculated on the total weight of the thickener composition.

10. A liquid composition comprising the thickener composition according to claim 1 and a binder.

11. The liquid composition according to claim 10,
wherein the liquid composition comprises
0.02 to 17.00 weight-% of the at least one associative thickener,
0.01 to 28.00 weight-% of the at least one anionic surfactant,
55.00 to 99.97 weight-% of the binder,
calculated on the total weight of the at least one associative thickener, the at least one anionic surfactant, and the binder.

12. A coated article, wherein at least a part of the surface of the article is coated with the liquid composition according to claim 10.

13. Method for improving the tinting viscosity stability of a liquid composition comprising
adding the thickener composition according to claim 1 to a liquid composition comprising a binder,
mixing,
adding one or more pigments and/or pigment composition, and
mixing.

14. Method for improving the tinting viscosity stability of a pigmented liquid composition comprising combining a liquid composition comprising a binder, a thickening composition according to claim 1 and a pigment.
